(19) United States
(12) Patent Application Publication
(10) Pub. No.: US 2023/0266585 A1
(43) Pub. Date: Aug. 24, 2023

(54) HEAD-MOUNTED DEVICES WITH MOVABLE OPTICAL ELEMENTS

(71) Applicant: HEWLETT-PACKARD DEVELOPMENT COMPANY, L.P., Spring, TX (US)

(72) Inventors: Derek Kyle Joseph Kanas, Spring, TX (US); Christopher Allan Steven, Spring, TX (US); Andre da Fonte Lopes da Silva, Palo Alto, CA (US)

(21) Appl. No.: 17/652,292

(22) Filed: Feb. 24, 2022

(51) Int. Cl. G02B 27/01

(52) U.S. Cl. CPC G02B 27/0101; G02B 27/0176; G02B 2027/014; G02B 2027/0198; G02B 2027/0134

(57) ABSTRACT

In some examples, a head-mounted device includes an image output device, and an optical element that is alternately moveable between a first position in which a first image output by the image output device is directed by the optical element towards a first location corresponding to a right eye position, and a second position in which a second image output by the image output device is directed by the optical element towards a second location corresponding to a left eye position.

### BACKGROUND

A head-mounted device refers to an electronic device that can be worn on a user's head. For example, a head-mounted device can include a headset, such as in the form of electronic goggles, in which images can be displayed in front of the user's eyes by respective display devices. In other examples, a head-mounted device can include electronic glasses.

### BRIEF DESCRIPTION OF THE DRAWINGS

Some implementations of the present disclosure are described with respect to the following figures.

FIGS. 1A and 1B are schematic diagrams of a head-mounted device that includes an image output device and an optical element that is movable between different positions, according to some examples.

FIG. 2 is a rear view of a head-mounted device that includes an image output device and a movable optical element, according to some examples.

FIG. 3 is a side sectional view of a head-mounted device according to some examples.

FIG. 4 is a block diagram of components of a head-mounted device to control a movable optical element, according to some examples.

FIG. 5 is a flow diagram of a process according to some examples.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

In the present disclosure, use of the term “a,” “an,” or “the” is intended to include the plural forms as well, unless the context clearly indicates otherwise. Also, the term “includes,” “including,” “comprises,” “comprising,” “have,” or “having” when used in this disclosure specifies the presence of the stated elements, but do not preclude the presence or addition of other elements.

In some examples, a head-mounted device can include multiple image output devices (e.g., multiple display devices), including a first image output device for a right eye of a user, and a second image output device for a left eye of the user.

As used here, an “image output device” can refer to any electronic output device that can produce an image that is visible to a user. The image output device can be in the form of a display device or an image projector, as examples. A “display device” refers to an output device with controllable optical elements (such as formed in an array) that can modulate an amount of light that is produced or passed through the respective optical elements. The modulated amount of light produced by or passed through the optical elements outputs an image.

A projector is able to generate an image, such as on a display device within the projector, and to emit light including the generated image to a remote surface (e.g., a projector screen, a wall, etc.) such that the generated image is visible on the remote surface.

The first image output device produces images for the right eye, while the second image of the device produces images for the left eye. The different images output by the image output devices allow the user to perceive a three-dimensional (3D) image or video.

The multiple image output devices of the head-mounted device draw power during operation of the image output devices. A power source of the head-mounted device can include a battery, which can be depleted relatively quickly when multiple image output devices are used. Plugging the head-mounted device to an external power source, such as a computer or a wall outlet, using a cable would address the power depletion issue, but makes the head-mounted device inconvenient for the user since the cable would prevent free movement of the user.

Moreover, the presence of multiple image output devices in the head-mounted device results in increased heat generation, which can be uncomfortable for the user. Also, with multiple image output devices, the head-mounted device is configured with heat dissipation components that adds to the complexity of the head-mounted device.

Additionally, the presence of multiple image output devices and associated components can add to the overall weight and cost of the head-mounted device.

In accordance with some implementations of the present disclosure, a head-mounted device includes a single image output device that produces images for both a left eye and a right eye of the user. To alternately provide different images to the left eye and the right eye, the head-mounted device includes an optical element that is alternately movable between a first position and a second position to alternately direct different images to a left eye position and a right eye position in the head-mounted device.

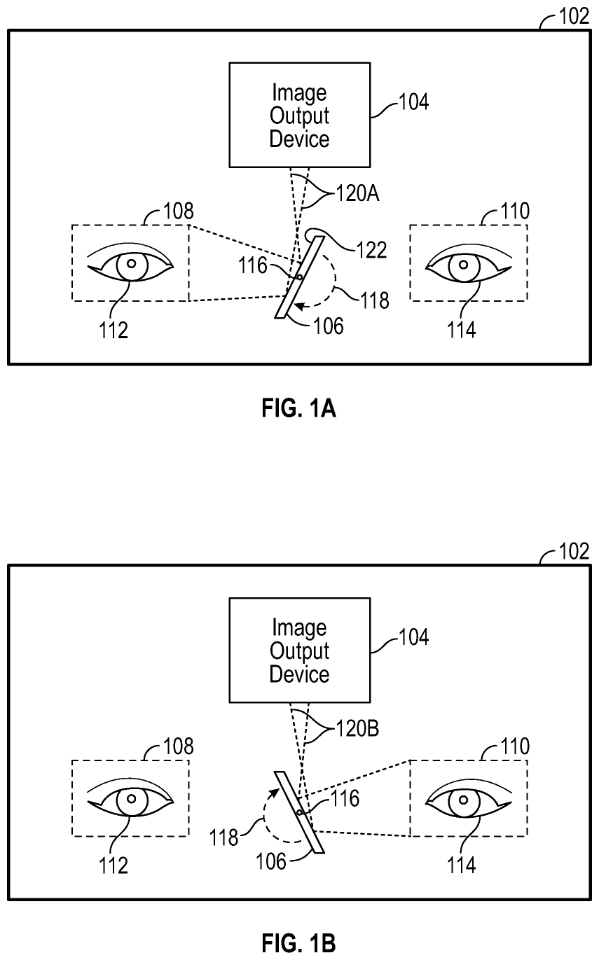

FIGS. 1A and 1B are schematic diagrams of a head-mounted device 102 that includes an image output device 104 and a movable optical element 106 that is alternately movable between a first position (as shown in FIG. 1A) and a second position (as shown in FIG. 1B). The image output device 104 can be in the form of a display device or a projector, for example.

FIG. 1A shows the movable optical element 106 in its first position. Light 120A output by the image output device 104 is redirected by the optical element 106 to a first region 108 that is proximate a right eye 112 of a user that is wearing the head-mounted device 102. The first region 108 is in front of the right eye 112 of the user. The light 120A contains an image generated by the image output device 104. The light 120A propagated by the optical element 106 to the first region 108 allows the right eye 112 of the user to view the image contained in the light 120A.

In some examples, the optical element 106 includes a mirror and thus has a reflective surface 122 that can reflect the light 120A towards the first region 108 when the optical element 106 is in its first position (FIG. 1A). In further examples, the optical element 106 can include a refractor or any other type of optical component (or arrangement of optical components such as optical waveguides and so forth) that is able to redirect the received light 120A towards a target region, which in FIG. 1A is the first region 108.

In some examples, the movable optical element 106 is rotatable about a pivot 116. The head-mounted device 102 can include a motor (or another type of actuator) to rotate the optical element 106.

As an example, the pivot 116 can include a pin attached to a housing or other structure of the head-mounted device 102. In some examples, the optical element 106 is rotatable along a rotational direction 118. In other examples, the optical element 106 is rotatable in the opposite rotational direction. In further examples, the optical element 106 is alternately rotatable back and forth in two opposite rotational directions about the pivot 116.

Although reference is made to rotating the optical element 106 to different positions, in other examples, the optical element 106 can be moved between different positions by sliding between different positions.

FIG. 1B shows the optical element 106 in its second position, such as after rotation from the first position of FIG. 1A along the rotational direction 118 to the second position of FIG. 1B.

In the second position, the optical element 106 redirects light 120B output by the image output device 104 to a second region 110 of the head-mounted device 102 that is proximate a front of the left eye 114 of the user.

Generally, the optical element 106 is alternately moveable between the first position in which a first image output by the image output device is directed by the optical element towards a first location corresponding to a right eye position, and a second position in which a second image output by the image output device is directed by the optical element towards a second location corresponding to a left eye position. The image output device 104 is positioned at a location of the head-mounted device 102 between the left eye position and the right eye position.

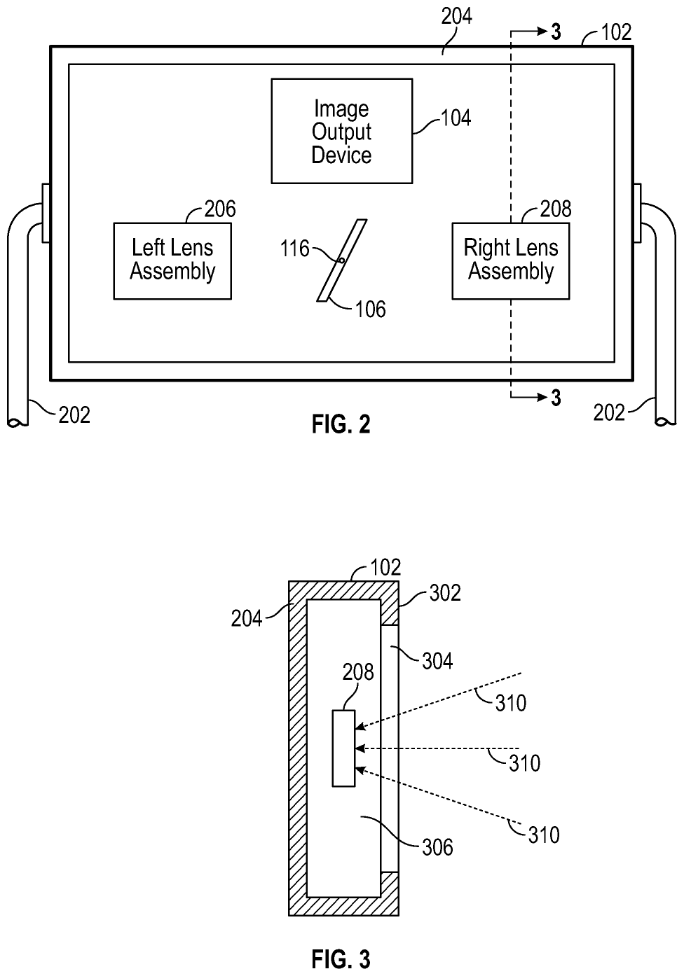

FIG. 2 is a schematic rear view of the head-mounted device 102. Straps 202 attached to a housing 204 of the head-mounted device 102 can be used to strap the head-mounted device 102 onto a user's head.

The head-mounted device 102 includes a left lens assembly 206 that is positioned in front of and proximate the left eye 114 of the user, and a right lens assembly 208 that is positioned in front of and proximate the user's right eye 112.

In some examples, each lens assembly 206 or 208 includes an optical component or an arrangement of optical components, such as waveguide(s) and lens(es), that can receive light redirected by the movable optical element 106 and propagate the received light from the optical element 106 to the respective region 108 or 110 in front of the right eye 112 or left eye 114, respectively.

FIG. 3 is a schematic side sectional view of the head-mounted device 102 taken along section 3-3 in FIG. 2. In some examples, a front portion 302 of the head-mounted device 102 includes a glass layer 304 that is attached to the housing 204 of the head-mounted device 102. The glass layer 304 is transparent to light, so that light (represented by arrows 310) from outside the head-mounted device 102, and more specifically, light in front of the head-mounted device 102, can enter through the glass layer 304 into an inner space 306 of the head-mounted device 102.

The outside light 310 that is passed from the outside of the head-mounted device 102 to the inner space 306 of the head-mounted device 102 can be received by the lens assembly 208 (and similarly the lens assembly 206) and propagated to the respective eye of the user wearing the head-mounted device 102. In examples with the glass layer 304, augmented reality content can be presented by the head-mounted device 102 to the user. Augmented reality content refers to content that includes a mix of both real-world objects as well as virtual reality content. The real-world objects are visible through the glass layer 304.

The virtual reality content is generated by a processor and output by the image output device 104 of the head-mounted device 102. The processor that generates the virtual reality content can be part of the head-mounted device 102, or alternatively, can be separate from the head-mounted device 102. In examples where the processor is external of the head-mounted device 102, the head-mounted device 102 can receive image data (either over a wired link or a wireless link) from the remote processor, such as a processor in a computer.

In alternative examples, the front portion 302 of the head-mounted device 102 is not provided with the glass layer 304, but rather includes an opaque layer of material such that light from outside the head-mounted device 102 does not enter into the inner space 306 of the head-mounted device 102. In such examples, the content output by the image output device 104 can include virtual reality content or any other type of content to be output by the image output device 104.

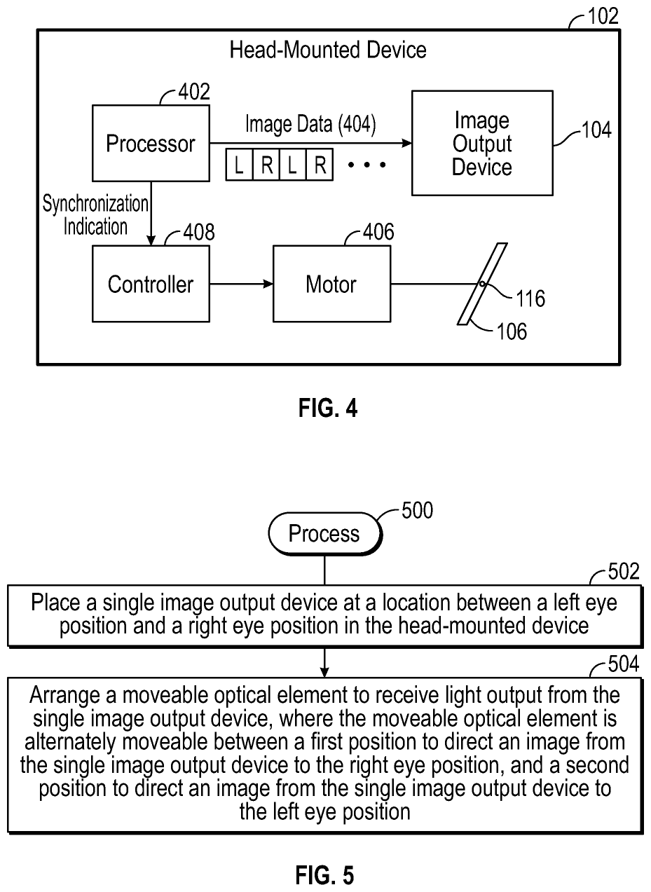

FIG. 4 is a block diagram of an example arrangement of components of the head-mounted device 102 according to some examples. In examples according to FIG. 4, it is assumed that the head-mounted device 102 includes a processor 402 that can generate image data 404. Note that the image data 404 can be generated by machine-readable instructions executable on the processor 402, in some examples. A processor can include a microprocessor, a core of a multi-core microprocessor, a microcontroller, a programmable integrated circuit, a programmable gate array, or another hardware processing circuit.

In other examples, the processor 402 may be external of the head-mounted device 102.

The image data 404 includes a series of image frames, including image frames for the left eye 114 (FIG. 1A) and image frames for the right eye 112. The image frames for the left eye are represented as “L” in FIG. 4, and the image frames for the right eye are represented as “R” frames in FIG. 4.

An “image frame” refers to an array of pixels that have respective values to form a target image.

The left and right image frames are arranged in an alternating manner, where a left image frame is followed immediately by a right image frame which is then followed immediately by a left image frame, and so forth. In other examples, other alternating arrangements of left and right image frames can be employed. More generally, a group of N (N≥1) left image frames is followed immediately by a group of N right image frames, and is followed immediately b a group of N left image frames, and so forth.

The image output device 104 has a refresh rate, which refers to how many times per second the image output device 104 is able to draw a new image. The refresh rate can be measured in terms of hertz (Hz). As an example, if the image output device 104 has a refresh rate of 120 Hz, the image output device 104 can refresh images at 120 times per second.

The rotational movement of the optical element 106 is provided by a motor 406 of the head-mounted device 102. The motor 406 can rotate the optical element 106 about the pivot 116. The motor 406 is controlled by a controller 408. In other examples, the motor 406 can be controlled by the processor 402

The operation of the motor 406 is synchronized with respect to the refresh rate of the image output device 104. Since just one image output device 104 is used in the head-mounted device 102, each eye sees half as many image frames as would be the case if two image output devices were used, one for each eye. To address the fact that each eye sees half as many image frames produced by the image output device 104, the image output device 104 can have a refresh rate that is twice the refresh rate of image output devices used in a head-mounted device with two image output devices.

For example, an image output device 104 with a refresh rate of 120 Hz, 144 Hz, and so forth, can be employed.

If the refresh rate of the image output device 104 is X Hz, where X is a number, then the motor 406 can rotate the optical element 106 X times per second. The optical element 106 moves at the same frequency as the refresh rate of the image output device 104. The optical element 106 successively moves between the first position and the second position to correspond to the right image frame and the left image frame, respectively. In this manner, the user will see a smooth 3D image although just one image output device is used in the head-mounted device 102.

More generally, the image output device 104 can output a sequence of image frames that alternate between first image frames for a left eye and second image frames for a right eye. The optical element 106 is alternately moveable between a first position in which a first image frame of the first image frames output by the image output device is directed by the optical element towards a first location corresponding to a right eye position, and a second position in which a second image frame of the second image frames output by the image output device is directed by the optical element towards a second location corresponding to a left eye position. The image output device 104 generates the sequence of image frames at a given refresh rate, and the optical element is alternately moveable between the first position and the second position at a same frequency as the given refresh rate.

The synchronization between the movement of the optical element 106 and the image data 404 is to allow the optical element 106 to be moved to a position to direct light to the left or right eye based on a left image frame or right image frame displayed by the image output device 104. For example, if the image output device 104 is outputting a left image frame, then the processor 402 provides a first synchronization indication to the controller 408 to cause the controller 408 to control the motor 406 such that the optical element 106 is moved to the second position of FIG. 1B.

On the other hand, if the image output device 104 is outputting a right image frame, then the processor 402 provides a second synchronization indication to the controller 408 to cause the controller 408 to control the motor 406 to move the optical element 106 to the first position of FIG. 1A.

A “synchronization indication” can refer to a signal, a command, an information element, or any other type of indicator that provides information to the controller 408 indicating which position the optical element 106 is to be moved to. For example, the synchronization indication can specify that the image output device 104 is outputting a right image frame or a left image frame, and the controller 408 can use this information to move the optical element 106 to the first position or the second position, respectively.

In other examples, the synchronization indication can instruct the controller 408 to move the optical element 106 to the first position or the second position.

FIG. 5 is a flow diagram of a process 500 of forming a head-mounted device (e.g., 102).

The process 500 includes placing (at 502) a single image output device at a location between a left eye position and a right eye position in the head-mounted device.

The process 500 includes arranging (at 504) a moveable optical element to receive light output from the single image output device, where the moveable optical element is alternately moveable between a first position to direct an image from the single image output device to the right eye position, and a second position to direct an image from the single image output device to the left eye position.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

1. A head-mounted device comprising:
a right lens assembly proximate to a right eye position;
a left lens assembly proximate to a left eye position, the left lens assembly aligned with the right lens assembly along a horizontal axis;
an image output device positioned above the right and left lens assemblies along a vertical axis perpendicular to the horizontal axis and positioned between the right and left lens assemblies along the horizontal axis; and
an optical element aligned with and centered between the right and left lens assembly along the horizontal axis and aligned with the image output device along the vertical axis, the optical element alternately moveable between a first position in which a first image output by the image output device is directly output to the optical element and then directed by the optical element towards a first location corresponding to the right eye position, and a second position in which a second image output by the image output device is directly output to the optical element and then directed by the optical element towards a second location corresponding to the left eye position.

2. The head-mounted device of claim 1, wherein the optical element is alternately rotatable between the first position and the second position.

3. The head-mounted device of claim 2, wherein the optical element is alternately rotatable between the first position and the second position according to a back-and-forth motion.

4. The head-mounted device of claim 2, wherein the optical element is alternately pivotable between the first position and the second position by rotating continually in a same rotational direction.

5. The head-mounted device of claim 1, wherein the image output device is a single display device to produce images for viewing by left and right eyes of a user wearing the head-mounted device.

6. The head-mounted device of claim 1, wherein the image output device is a single projector to produce images for viewing by left and right eyes of a user wearing the head-mounted device.

7. The head-mounted device of claim 1, wherein the image output device is to produce images at a given refresh rate, and the optical element is alternately moveable between the first position and the second position at a same frequency as the given refresh rate.

8. The head-mounted device of claim 1, wherein the optical element comprises a mirror, and the image output device is to direct light towards the mirror.

9. The head-mounted device of claim 1, wherein the optical element when at the first position is to direct light towards the right lens assembly, and wherein the optical element when at the second position is to direct light towards the left lens assembly.

10. (canceled)

11. The head-mounted device of claim 1, further comprising a motor to move the optical element.

12. A head-mounted device comprising:
an image output device to output a sequence of image frames that alternate between first image frames for a left eye and second image frames for a right eye; and
an optical element aligned with the image output device along a vertical axis, the optical element alternately moveable between a first position in which a first image frame of the first image frames output by the image output device is directly output to the optical element and then directed by the optical element towards a first location corresponding to a right eye position, and a second position in which a second image frame of the second image frames output by the image output device is directly output to the optical element and then directed by the optical element towards a second location corresponding to a left eye position,
wherein the image output device is to generate the sequence of image frames at a given refresh rate, and the optical element is alternately moveable between the first position and the second position at a same frequency as the given refresh rate,
and wherein the right and left eye positions are aligned along a horizontal axis perpendicular to the vertical axis.

13. The head-mounted device of claim 12, comprising:
a controller to synchronize a movement of the optical element with image frames output by the image output device.

14. A method of forming a head-mounted device, comprising:
placing a single image output device at a location vertically above and horizontally centered between a left eye position and a right eye position in the head-mounted device; and
arranging a moveable optical element vertically below and vertically aligned with the single image output device and horizontally aligned with and horizontally centered between the left and right eye positions to directly receive light output from the single image output device, wherein the moveable optical element is alternately moveable between a first position to direct an image from the single image output device to the right eye position, and a second position to direct an image from the single image output device to the left eye position.

15. The method of claim 14, wherein the moveable optical element comprises a mirror.

16. The head-mounted device of claim 12, wherein the image output device is positioned above the right and left eye positions along the vertical axis and is positioned between the right and left eye positions along the horizontal axis.

17. The head-mounted device of claim 16, wherein the optical element is aligned with and centered between the right and left eye positions along the horizontal axis.
